(19) United States
(12) Patent Application Publication
(10) Pub. No.: US 2015/0205410 A1
(43) Pub. Date: Jul. 23, 2015

(54) METHOD FOR DETECTING TOUCH POINTS ON A CAPACITIVE TOUCH PANEL

(71) Applicant: TIANJIN FUNAYUANCHUANG TECHNOLOGY CO.,LTD., Tianjin (CN)

(72) Inventors: CHIEN-YUNG CHENG, New Taipei (TW); PO-SHENG SHIH, New Taipei (TW)

(21) Appl. No.: 14/601,258

(22) Filed: Jan. 21, 2015

(30) Foreign Application Priority Data
Jan. 23, 2014 (CN) 201410031617.X

(51) Int. Cl. G06F 3/044; G06F 3/041

(52) U.S. Cl. CPC G06F 3/044; G06F 3/0416; G06F 2203/04111; G06F 2203/04112

(57) ABSTRACT

A method for determining touch point coordinates on capacitive type touch panel includes following steps. A touch panel with single conductive layer with a number of first electrodes and a number of second electrodes is provided, wherein each of first electrodes and second electrodes includes a number of regions with different resistance respectively. A first signal value A_{1T} by inputting driving electrical signals to each first electrode for 1T, wherein T is single charging cycle time of a driving and sensing unit. A second signal value B_{1T} is obtained by inputting driving electrical signals to each second electrode for 1T. A third signal value is A_{2T} obtained by inputting driving electrical signals to each first electrode again for 3T; and a fourth signal value B_{2T} is obtained by inputting driving electrical signals to each second electrode again for 3T.

### CROSS-REFERENCE TO RELATED APPLICATIONS

This application claims all benefits accruing under 35 U.S.C. §119 from China Patent Application No. 201410031617.X, filed on Jan. 23, 2014, in the China Intellectual Property Office, the disclosure of which is incorporated herein by reference.

### BACKGROUND

1. Technical Field

The present disclosure relates to a method for determining touch point coordinates, particularly to a method for determining touch point coordinates on capacitive type touch panel.

2. Description of Related Art

Touch panels or touch screens are widely applied in electronic apparatuses, particularly in portable or hand-held electronic apparatuses, such as personal digital assistants (PDA) or mobile phones. Touch panels involve integration of resistive-type, capacitive-type or optical touch technologies and display panels.

A conventional capacitive-type touch panel includes two pattern layers made of transparent conductive materials formed on two surfaces of a glass substrate respectively to detect two-dimensional coordinates on the pattern layers. The transparent conductive material of conventional touch panel is indium tin oxide (ITO). Recently, the research is focus on the capacitive-type touch panel with single layer of transparent conductive material. The single layer of transparent conductive material comprises a plurality of triangular electrodes extending along the same direction (X direction) and aligned side to side. Each two adjacent electrodes are coupled together to detect the touch point. However, the touch panel cannot distinguish the two points on the extending direction. Therefore, the touch panel is not suitable for multi-touching.

What is needed, therefore, is to provide a method for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an embodiment of a touch panel.

FIG. 2 shows a schematic view of a conductive layer in the touch panel of FIG. 1.

FIG. 3 shows a flow chart of one embodiment of a method of determining touch point coordinates on touch panel.

FIG. 4 shows a schematic view of one embodiment of a method of determining coordinate of touch point TP1 and coordinate of touch point TP2.

FIG. 5 shows a schematic view of one embodiment of a touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

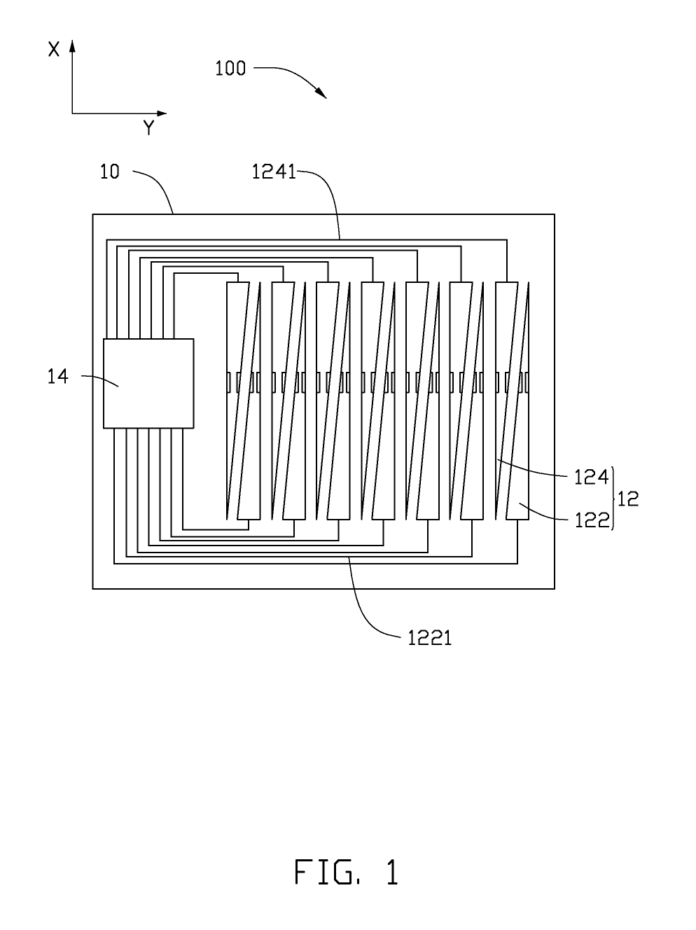

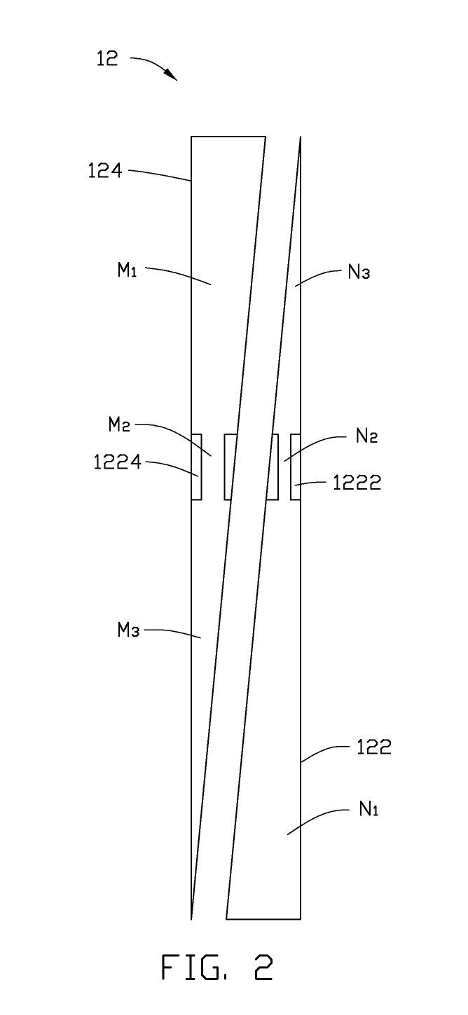

Referring to FIG. 1 and FIG. 2, one embodiment of a capacitive-type touch panel 100 with single conductive layer comprises an insulating substrate 10 and a conductive layer 12 located on the insulating substrate 10. The conductive layer 12 comprises a plurality of first electrodes 122 and a plurality of second electrodes 124 extending along the same direction. Furthermore, the plurality of first electrodes 122 and the plurality of electrodes 124 are spaced from each other and alternatively located on the insulating substrate 10.

The insulating substrate 10 having a plane structure or a curved structure. The insulating substrate 10 can be transparent. The insulating substrate 10 can be formed using transparent material, such as polyethylene (PE), polycarbonate (PC), polyethylene terephthalate (PET), polymethyl methacrylate (PMMA), polyimide (PI), polyether sulphone (PES), cellulose resin, polyvinylchloride (PVC), benzocyclobutene (BCB), acrylic resin, glass, or quartz, for example. In one embodiment, the insulating substrate 10 has a plane structure and is formed by polycarbonate.

The conductive layer 12 can be a carbon nanotube layer, an indium tin oxide (ITO) layer, or an antimony tin oxide (ATO) layer. The conductive layer 12 can have a thickness of about 0.5 nanometers (nm) to about 100 micrometers (um). In one embodiment, the conductive layer 12 has a thickness of about 100 nm to about 200 nm.

The plurality of first electrodes 122 and the plurality of second electrodes 124 can extend along X direction and aligned along Y direction perpendicular to the X direction. The plurality of first electrodes 122 and the plurality of second electrodes 124 are alternatively aligned along the Y direction. It means that each first electrode 122 is sandwiched between two adjacent second electrodes 124, and each second electrode 124 is sandwiched between two adjacent first electrodes 122.

Furthermore, the adjacent first electrode 122 and second electrode 124 are coupled together. The shape of the first electrode 122 and the shape of the second electrode 124 are complementary, thus the detection region of the touch panel can nearly cover the insulating substrate 100. A distance between the first electrode 122 and the second electrode 124 can be selected according to the touch resolution requirement of the touch panel 100 to meet the actual requirements of different devices.

Each of the plurality of first electrodes 122 comprises a first end and a second end along the X direction. A size of the first electrode 122 along the Y direction is defined as width of the first electrode 122. A first width on the first end is greater than a second width of the first electrode 122 on the second end. In one embodiment, the width of the first electrode 122 is gradually decreased from the first end to the second end. In one embodiment, each of the plurality of first electrodes 122 is in a shape of triangle.

In one embodiment, the first electrode 122 comprises three regions with different resistance along the X direction. The first electrode 122 comprises a first region N₁, a second region N₂, and a third region N₃ from the first end to the second end. The first region Nᵢ has a first resistance R_{N1}, the second region N₂ has a second resistance R_{N2}, and the third region has a third resistance R_{N3}. The first resistance R_{N1}, the second resistance R_{N2}, and the third resistance R_{N3} satisfy R_{N1}≠R_{N2}≠R_{N3}.

Referring to FIG. 2, two first recesses 1222 can be formed between the first end and the second end in the first electrode 122. The two first recesses 1222 are formed on two opposite edges of the first electrode 122 and opposite with each other along the Y direction. The region on one side of the two first recesses 1222 is defined as the first region N₁, the region on another side of the two first recesses 1222 is defined as the third region N₃, and the region between the two first recesses 1222 is defined as the second region N₂. Because the first region N₁, the second region N₂, and the third region N₃ have different width, thus the resistance of the first region N₁, the second region N₂, and the third region N₃ are different from each other.

The two first recesses 1222 are spaced from each other and extend from the edge into inside of the first electrode 122. Thus the first electrode 122 is not broken up by the two first recesses 1222 along the X direction. The shape of each of the two first recesses 1222 can be rectangular, semi-circular, triangular, or other geometric shape. A length of each of the two first recesses 1222 along the X direction can be selected according to the charging time and discharging time of the driving and sensing circuit. During single charging cycle time, merely the capacity of the first region N₁ can be fully charged by the driving and sensing circuit. During over 3 times charging cycle times, all of the capacity of the first region N₁, the second region N₂, and the third region N₃ can be fully charged.

The structure of the second electrode 124 is similar with the first electrode 122, except that the width of the second electrode 124 is gradually increased along the X direction to form an inverted triangle along the X direction. In detail, the second electrode 124 comprises a third end and a forth end along the X direction. A third width of the third end is smaller than a fourth width of the fourth end of the second electrode 124. Thus the third end of the second electrode 124 can complementary to the first end of the first electrode 122, and the fourth end of the second electrode 124 can complementary to the second end of the first electrode 122. Therefore, the inverted triangular second electrode 124 is coupled with the triangular first electrode 122 to form a rectangle.

The second electrode 124 comprises a third region M₃, a second region M₂, and a first region M₁ from the third end to the fourth end. The first region M₁ has a first resistance R_{M1}, the second region M₂ has a second resistance R_{M2}, and the third region has a third resistance R_{M3}. The first resistance R_{M1}, the second resistance R_{M2}, and the third resistance R_{M3} satisfy Rₘ₁≠Rₘ₂≠Rₘ₃.

Two second recesses 1242 can be defined between the third end and the fourth end in the second electrode 124. The two second recesses 1242 are formed on two opposite edges of the second electrode 124 and opposite with each other along the Y direction. The region on one side of the two second recesses 1242 is defined as the first region M₁, the region on another side of the two second recesses 1242 is defined as the third region M₃, and the region between the two second recesses 1242 is defined as the second region M₂. Because the first region M₁, the second region M₂, and the third region M₃ have different width, thus the resistance of the first region M₁, the second region M₂, and the third region M₃ are different from each other. Furthermore, the two second recesses 1242 and the two first recesses 1222 are aligned along the Y direction. Thus the two second recesses 1242 and the two first recesses 1222 have the same X-coordinates.

Furthermore, both the first electrode 122 and the second electrode 124 can have more than three different regions with different resistance along X direction. In one embodiment, both the first electrode 122 and the second electrode 124 can have five different regions. In another embodiment, both the first electrode 122 and the second electrode 124 have seven different regions.

Because both the first electrode 122 and the second electrode 124 have at least three different regions with at least three different resistances along X direction, the two touch points coordinates on the touch panel along X direction can be detected and determined.

Furthermore, the touch panel 100 comprises a plurality of first electrode leads 1221 and a plurality of second electrode leads 1241 distributed on two opposite sides of the conductive layer 12. The plurality of first electrode leads 1221 are electrically connected to the plurality of first electrode 122, and the plurality of second electrode leads 1241 are electrically connected to the plurality of second electrode 124.

Furthermore, the touch panel 100 comprises a driving and sensing unit 14 to inputs driving electrical signals to conductive layer 12 and read out sensed electrical signals of the touch points on the touch panel. The driving and sensing unit 14 is electrically connected to the conductive layer 12 via the plurality of first electrodes 122 and the plurality of second electrodes 124.

The charging cycle time T of the driving and sensing unit 14 is determined by the RC loading of the driving and sensing unit 14. During single charging cycle time 1T, merely the capacity of the first region can be fully charged. During double times charging cycle time 2T, both the capacity of the first region and the second region can be fully charged. Above three times charging cycle time 3T, the capacity of the first region, the second region, and the third region can be fully charged.

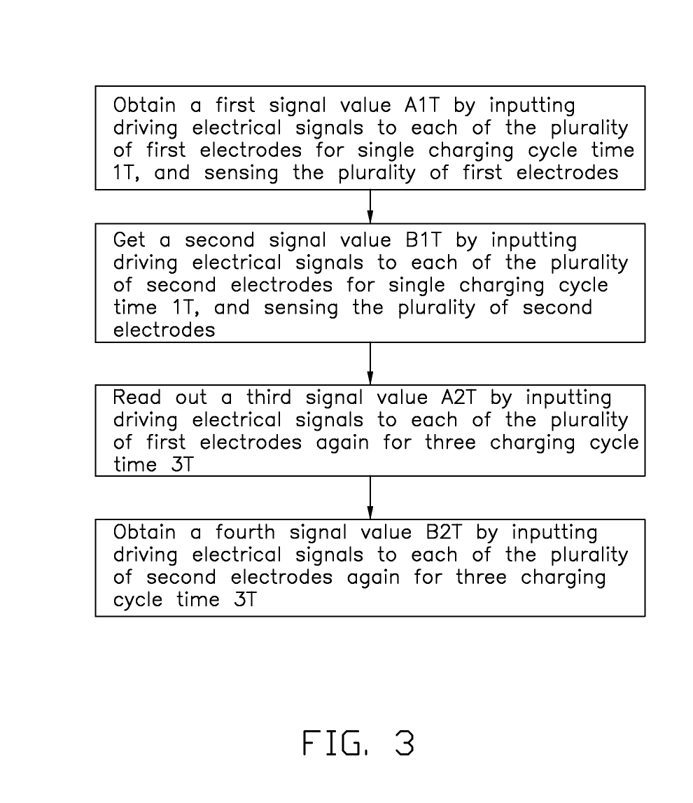

Referring to FIG. 3, a method of one embodiment of determining touch point coordinates on the touch panel 100 comprises:

step (S10), obtaining a first signal value A_{1T} by inputting driving electrical signals to each of the plurality of first electrodes 122 for single charging cycle time 1T, and sensing the plurality of first electrodes 122;

step (S20), getting a second signal value B_{1T} by inputting driving electrical signals to each of the plurality of second electrodes 124 for single charging cycle time 1T, and sensing the plurality of second electrodes 124;

step (S30), reading out a third signal value A_{2T} by inputting driving electrical signals to each of the plurality of first electrodes 122 again for three charging cycle time 3T; and

step (S40), obtaining a fourth signal value B_{2T} by inputting driving electrical signals to each of the plurality of second electrodes 124 again for three charging cycle time 3T.

In step (S10), during the time of 1T, the driving and sensing unit 14 can merely fully charge the capacity of the first region N₁. Because of the resistance, the second region N₂ and the third region N₃ are not charged or fully charged. Thus during the sensing process, the touch point on the first region N₁ can be read out as the first signal value A_{1T} through the plurality of first electrodes 122. During sensing each of the plurality of first electrodes 122, the plurality of second electrodes 124 and other first electrodes 122 which are not sensed can be grounded, floating, or supplied with a potential. In one embodiment, the plurality of second electrodes 124 and other first electrodes 122 which are not sensed are floating.

In step (S20), during the time of 1T, merely the capacity of the first region M₁ can be fully charged. Because of the resistance, the second region M₂ and the third region M₃ are not charged or fully charged. Thus during the sensing process, the touch point on the first region M₁ can be read out as the first signal value B_{1T} through the plurality of second electrodes 124. During sensing each of the plurality of second electrodes 124, the plurality of first electrodes 122 and other second electrodes 124 which are not sensed can be grounded, floating, or supplied with a potential.

In step (S30), during the time of 3T, all of the first region N₁, the second region N₂, and the third region N₃ can be fully charged by the driving and sensing unit 14. During the sensing process, the touch point on the first region N₁, the second region N₂, or the third region N₃ can be read out as the third signal value A_{2T} through the plurality of first electrodes 122. During sensing each of the plurality of first electrodes 122, the plurality of second electrodes 124 and other first electrodes 122 which are not sensed can be grounded, floating, or supplied with a potential. In one embodiment, the plurality of second electrodes 124 and other first electrodes 122 which are not sensed are floating.

In step (S40), during the time of 3T, all of the first region M₁, the second region M₂, and the third region M₃ can be fully charged by the driving and sensing unit 14. During the sensing process, the touch point on the first region M₁, the second region M₂, or the third region M₃ can be read out as the third signal value B_{3T} through the plurality of second electrodes 124. During sensing each of the plurality of second electrodes 124, the plurality of first electrodes 122 and other second electrodes 124 which are not sensed can be grounded, floating, or supplied with a potential. In one embodiment, the plurality of first electrodes 122 and other second electrodes 124 which are not sensed are floating.

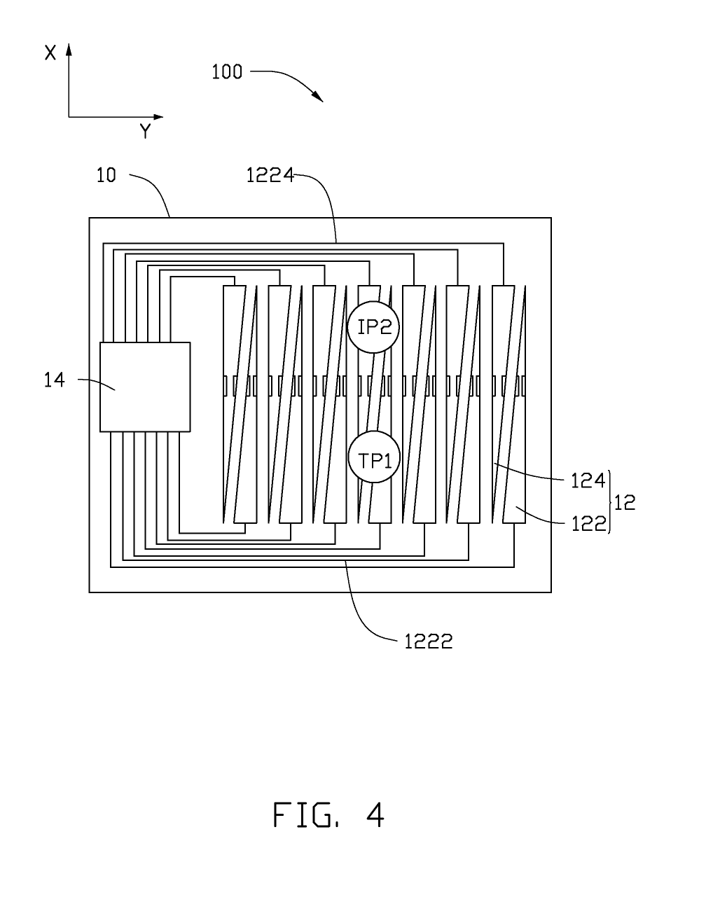

Referring to FIG. 4, a first touch point TP1 and a second touch point TP2 are formed along the X direction. The first touch point TP1 is adjacent to the first electrode 122, and the second touch point TP2 is adjacent to the second electrode 124.

The coordinates of the first touch point TP1 and the second touch point TP2 can be calculated through the first signal value A_{1T}, the second signal value B_{1T}, the third signal value A_{2T}, and the fourth signal value B_{2T} as follows:

A_{1T}=A_{1P};

A_{2T}=A_{1P}+A_{2P},

B_{1T}=B_{1P};

B_{2T}=B₁ₚ+B_{2P};

wherein A₁ₚ is the touch point signal caused by the first touch point TP1 and sensed by the plurality of first electrodes 122, and B₁ is the touch point signal caused by the first touch point TP1 and sensed by the plurality of second electrodes 124. A_{2P} is the touch point signal caused by the second touch point TP2 and sensed by the plurality of first electrodes 122, and B_{2P} is the touch point signal caused by the second touch point TP2 and sensed by the plurality of second electrodes 124.

Thus the A_{1P}, B_{1P}, A_{2P}, B_{2P} can be expressed as:

A_{1P}=A_{1T};

B_{1P}=B_{2T}−B_{2P}=B_{2T}−B_{1T};

A_{2P}=A_{2T}−A_{1P}=A_{2T}−A_{1T};

B_{2P}=B_{1T}.

Thus the coordinate X₁ of the first touch point TP1 and the coordinate X₂ of the second touch point TP2 can be calculated as:

$$\begin{matrix}{X}_{1} = \frac{{P}_{X}}{2} + \frac{( {A}_{1 P} - {B}_{1 P} )}{( {A}_{1 P} + {B}_{1 P} )} \times \frac{{P}_{X}}{2} \\ = \frac{{P}_{X}}{2} + \frac{( {A}_{1 T} - ( {B}_{2 T} - {B}_{1 T} ) )}{( {A}_{1 T} + ( {B}_{2 T} - {B}_{1 T} ) )} \times \frac{{P}_{X}}{2} ;\end{matrix}$$

$$\begin{matrix}{X}_{2} = \frac{{P}_{X}}{2} + \frac{( {A}_{2 P} - {B}_{2 P} )}{( {A}_{2 P} + {B}_{2 P} )} \times \frac{{P}_{X}}{2} \\ = \frac{{P}_{X}}{2} + \frac{( {A}_{2 T} - {A}_{1 T} - {B}_{1 T} )}{( {A}_{2 T} - {A}_{1 T} + {B}_{1 T} )} \times \frac{{P}_{X}}{2} .\end{matrix}$$

wherein P_{X} is a resolution of the X direction of the touch panel 100. In one embodiment, the value of the resolution can be set by the driving detecting unit 14, for example, the value is in the range of 480 to 1024.

Furthermore, the X₁ and X₂ can be used to determine whether there are two touch points or there is single touch point on the touch panel. l₀ is set as the threshold value which the touch panel 100 can recognize along the X direction. While |X1−X2|<l₀, the two touch points TP1 and TP2 cannot be recognized by the touch panel, thus the first touch point TP1 and the second touch point TP2 will be recognized as single touch point. Then the touch panel 100 can be responded to the single touch point in the following process. l₀ can be selected according to the resolution along the X direction.

In one embodiment, the first electrode 122 is divided into n regions. Thus the n regions will be fully charged after a time of nT. The second electrode 124 is divided into m regions, and the m regions will be fully charged after a time of mT. Then the coaxial touch points can be obtained through more than two groups of signals as described above.

The method of determining touch point coordinates on touch panel has following advantages. The conductive layer has been patterned by the recesses, thus the plurality of regions with different resistance can be formed, and the two different touch points on the X direction can be obtained. Thus the detection accuracy and the sensitivity of the touch can be improved.

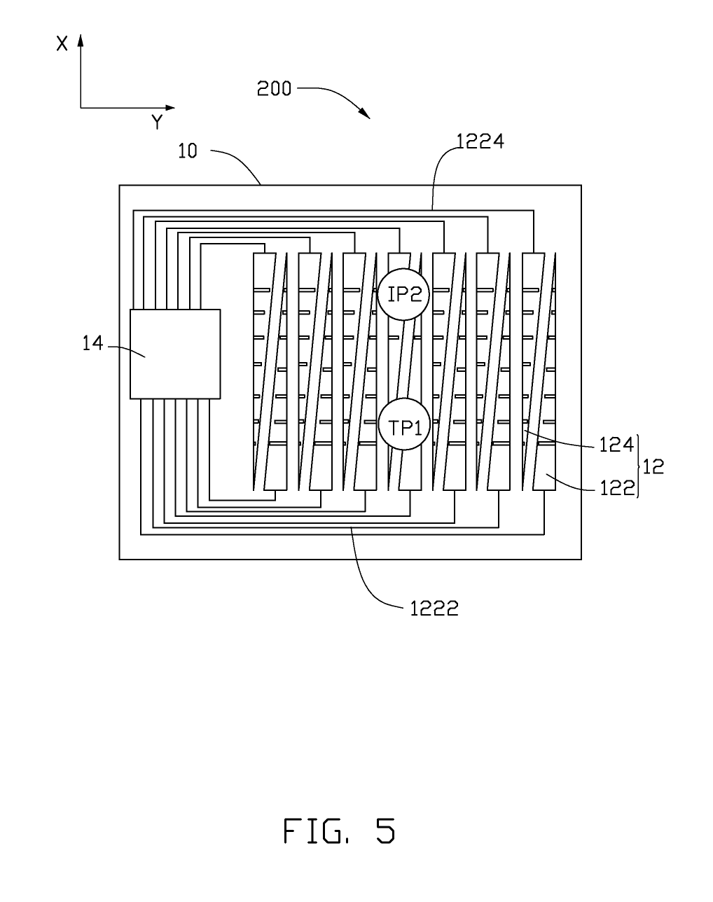

Referring to FIG. 5, a capacitive-type touch panel 200 of one embodiment comprises an insulating substrate 10, and a conductive layer 14 on the insulating substrate 10. The conductive layer 14 comprises a plurality of first electrodes 122 and a plurality of second electrodes 124 spaced from each other and alternatively located on the insulating substrate 10. The structure of the touch panel 200 is similar to the touch panel 100, except that each of the plurality of first electrodes 122 comprises i regions with different resistance: N₁, N₂, . . . Nᵢ; and each of the plurality of second electrodes 124 comprises i regions with different resistance: M₁, M₂, . . . , Mᵢ corresponding to the regions Nᵢ, Nᵢ₋₁, . . . N₂, N₁ respectively, wherein i≧3.

A method of one embodiment for determining touch panel coordinates on the touch panel comprises:

step (S10), obtaining a plurality of first signal values A_{1T}, A_{2T}, A_{1T} by inputting driving electrical signals to each of the plurality of first electrodes 122 for 1T, 3T, . . . , iT respectively, and sensing the plurality of first electrodes 122 for each time; and

step (S20), getting a plurality of second signal values B_{1T}, B_{1T}, . . . , B_{iT} by inputting driving electrical signals to each of the plurality of second electrodes 124 for 1T, 3T, iT respectively, and sensing the plurality of second electrodes 124 for each time.

The two touch point coordinates of the two touch points along the X direction can be calculated through the plurality of first signal values A_{1T}, A_{2T}, A_{1T} and the plurality of second signal values B_{1T}, B_{1T}, . . . , B_{iT}. A first group values of relationship between the two touch point coordinates can be deduced by making difference between each adjacent two of the plurality of first signal values A_{1T}, A_{2T}, . . . , A_{iT} one by one. A second group values of relationship between the two touch point coordinates can be deduced by making difference between each adjacent two of the plurality of second values B_{1T}, B_{1T}, B_{iT} one by one. Then the touch point coordinates of TP1 and TP2 can be calculated through the first group values and the second group values.

In one embodiment, the first touch point TP1 is located at the region Nⱼ, and the second touch point TP2 is located at the region Nₖ in the first electrode 122. Thus for the second electrode 122, the first touch point TP1 is located at the region Nᵢ₋ⱼ, and the second touch point TP2 is located at the region Nᵢ₋ₖ.

A first signal value A_{T} sensed by the first electrode 122 while the first electrode 122 sensing the region Nⱼ wherein the first touch point TP1 is located can be expressed as:

A_{jT}=A_{1P}+A_{(j-2)T};
wherein A_{1P} is the signal value caused by the first touch point TP1 in region Nⱼ and sensed by the first electrode 122, and A_{(j-2)T} is the signal value of the regions from N₁ to Nⱼ₋₂ sensed by the first electrode 122 during (j−2)T.

A second signal value A_{kT} sensed by the first electrode 122 while the first electrode 122 sensing the region Nₖ wherein the second touch point TP2 is located can be expressed as:

A_{kT}=A_{2P}+A_{(k-2)T};

wherein A_{2P} is the signal value caused by the second touch point TP2 in region Nₖ and sensed by the first electrode 122, and A_{(k-2)T} is the signal value of the regions from N₁ to Nₖ₋₂ sensed by the first electrode 122 during (k−2)T.

A third signal value B_{(i-k)T} sensed by the second electrode 124 while the second electrode 124 sensing the region N₍ᵢ₋ₖ₎ wherein the second touch point TP2 is located can be expressed as:

B_{(i-k)T}=B_{2P}+B_{(i-k-2)T};

wherein B_{2P} is the signal value caused by the second touch point TP2 in region Nᵢ₋ₖ and sensed by the second electrode 124, and B_{(i-k-2)T} is the signal value of the regions from N₁ to Nₖ₋₂ sensed by the second electrode 124 during (i−k−2)T.

A fourth signal value B_{(i-j)T} sensed by the second electrode 124 while the second electrode 124 sensing the region N₍ᵢ₋ⱼ₎ wherein the first touch point TP1 is located can be expressed as:

B_{(i-j)T}=B_{2P}+B_{(i-j-2)T};

wherein B_{2P} is the signal value caused by the first touch point TP1 and sensed by the first electrode 122, and B_{(i-j-2)T} is the signal value of the regions from N₁ to Nᵢ₋ⱼ₋₂ sensed by the first electrode 122 during (i−j−2)T.

Therefore, the A_{1P}, B_{1P}, A_{2P}, B_{2P} can be expressed as:

A_{1P}=A_{jT}−A_{(j-2)T};

A_{2P}=A_{kT}−A_{(k-2)T};

B_{1P}=B_{(i-k)T}−B_{(i-k-2)T},

B_{2P}=B_{(i-j)T}−B_{(i-j-2)T}.

Thus the coordinate X₁ of the first touch point TP1 and the coordinate X₂ of the second touch point TP2 can be calculated as:

$$\begin{matrix}{X}_{1} = \frac{{P}_{X}}{2} + \frac{( {A}_{1 P} - {B}_{1 P} )}{( {A}_{1 P} + {B}_{1 P} )} \times \frac{{P}_{X}}{2} \\ = \frac{{P}_{X}}{2} + \frac{( {A}_{jT} - {A}_{( j - 2 ) T} - ( {B}_{( i - k ) T} - {B}_{( i - k - 2 ) T} ) )}{( {A}_{jT} - {A}_{( j - 2 ) T} + ( {B}_{( i - k ) T} - {B}_{( i - k - 2 ) T} ) )} \times \frac{{P}_{X}}{2} ;\end{matrix}$$

$$\begin{matrix}{X}_{2} = \frac{{P}_{X}}{2} + \frac{( {A}_{2 P} - {B}_{2 P} )}{( {A}_{2 P} + {B}_{2 P} )} \times \frac{{P}_{X}}{2} \\ = \frac{{P}_{X}}{2} + \frac{( {A}_{kT} - {A}_{( k - 2 ) T} - ( {B}_{( i - j ) T} - {B}_{( i - j - 2 ) T} ) )}{( {A}_{kT} - {A}_{( k - 2 ) T} + ( {B}_{( i - j ) T} - {B}_{( i - j - 2 ) T} ) )} \times \frac{{P}_{X}}{2} .\end{matrix}$$

wherein P_{X} is a resolution of the X direction of the touch panel 200. In one embodiment, the value of the resolution can be set by the driving detecting unit 14, for example, the value is in the range of 480 to 1024.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A method for detecting touch points on a capacitive touch panel, the method comprising:
providing a touch panel comprising a conductive layer, wherein the conductive layer comprises a plurality of first electrodes and a plurality of second electrodes extending along a X direction, the plurality of first electrodes and the plurality of electrodes are spaced from each other and alternatively located along a Y direction intersected with the X direction, each of the plurality of first electrodes comprises a first region N₁, a second region N₂, and a third region N₃ with different resistance along the X direction, and each of the plurality of second electrodes comprises a third region M₃, a second region M₂, and a first region M₁ with different resistance along the X direction;
obtaining a first signal value A_{1T} by inputting driving electrical signals to each of the plurality of first electrodes for 1T, and sensing the plurality of first electrodes one by one, wherein T is a single charging cycle time of a driving and sensing unit;
getting a second signal value B_{1T} by inputting driving electrical signals to each of the plurality of second electrodes for 1T, and sensing the plurality of second electrodes one by one;
reading out a third signal value A_{2T} by inputting driving electrical signals to each of the plurality of first electrodes again for 3T, and sensing the plurality of first electrodes one by one; and
obtaining a fourth signal value B_{2T} by inputting driving electrical signals to each of the plurality of second electrodes again for 3T, and sensing the plurality of second electrodes one by one, wherein touch point coordinates of touch points are calculated through the first signal value A_{1T}, the second signal value A_{2T}, the third signal value B_{1T}, and the third signal value B_{2T}.

2. The method of claim 1, wherein a material of the conductive layer is indium tin oxide or an antimony tin oxide.

3. The method of claim 1, wherein a shape of each of the plurality of first electrodes is triangle along the X direction, and a shape of each of the plurality of second electrode is inverted triangle along the X direction and coupled with the first electrode.

4. The method of claim 1, wherein two opposite first recesses are defined at two opposite sides of each of the plurality of first electrode along the Y direction, a region on one side of the two opposite first recesses along the X direction is defined as the first region N₁, a region on the other side of the two opposite first recesses along the X direction is defined as the third region N₃, and a region between the opposite two first recesses is defined as the second region N₂.

5. The method of claim 1, wherein two opposite second recesses are defined at two opposite sides of each of the plurality of second electrode along the Y direction, a region on one side of the two opposite second recesses along the X direction is defined as the first region M₁, a region on the other side of the two opposite second recesses along the X direction is defined as the third region M₃, and a region between the opposite two second recesses is defined as the second region M₂.

6. The method of claim 1, wherein a capacity of the first region N₁ in the first electrode is fully charged by the driving and sensing unit during 1T.

7. The method of claim 1, wherein a capacity of the first region M₁ in the second electrode is fully charged by the driving and sensing unit during 1T.

8. The method of claim 1, wherein all of the first region N₁, the second region N₂, and the third region N₃ are fully charged by the driving and sensing unit during 3T.

9. The method of claim 1, wherein all of the first region M₁, the second region M₂, and the third region M₃ are fully charged by the driving and sensing unit during 3T.

10. The method of claim 1, wherein a first coordinate X1 of a first touch point TP1 and a second coordinate X2 of a second touch point TP2 are calculated by:
$${X}_{1} = \frac{{P}_{X}}{2} + \frac{( {A}_{1 T} - ( {B}_{2 T} - {B}_{1 T} ) )}{( {A}_{1 T} + ( {B}_{2 T} - {B}_{1 T} ) )} \times \frac{{P}_{X}}{2} ;$$
$${X}_{2} = \frac{{P}_{X}}{2} + \frac{( {A}_{2 T} - {A}_{1 T} - {B}_{1 T} )}{( {A}_{2 T} - {A}_{1 T} + {B}_{1 T} )} \times \frac{{P}_{X}}{2} ,$$
wherein P_{X} is a resolution of the X direction of the touch panel.

11. The method of claim 10, further comprising adjusting the first touch point TP1 and the second touch point TP2 by comparing X1 with X2:
calculating |X1−X2|;
comparing |X1−X2| with l₀, wherein a threshold value which the touch panel is capable of recognizing along the X direction is defined as l₀; and
while |X1−X2|<l₀, the first touch point TP1 and the second touch point TP2 is recognized as single touch point by the touch panel.

12. The method of claim 1, wherein some of the plurality of first electrodes and the plurality of second electrodes which are not sensed are grounded or floating.

13. A method for detecting touch points on a capacitive touch panel comprising:
providing a touch panel comprising a conductive layer, wherein the conductive layer comprises a plurality of first electrodes and a plurality of second electrodes extending along a X direction, the plurality of first electrodes and the plurality of electrodes are spaced from each other and alternatively located along a Y direction intersected with the X direction, each of the plurality of first electrodes comprises i regions N₁, N₂, . . . Nⱼ, . . . Nₖ, . . . Nᵢ with different resistance along the X direction, and each of the plurality of second electrodes comprises i regions M₁, M₂, . . . Mⱼ . . . Mₖ, . . . Mᵢ with different resistance along the X direction, wherein i≧3;
obtaining a plurality of first signal values A_{1T}, A_{2T}, . . . , A_{iT} by inputting driving electrical signals to each of the plurality of first electrodes for 1T, 3T, . . . , iT respectively, and sensing the plurality of first electrodes for each time;
getting a plurality of second signal values B_{1T}, B_{1T}, . . . , B_{iT} by inputting driving electrical signals to each of the plurality of second electrodes for 1T, 3T, . . . , iT respectively, and sensing the plurality of second electrodes for each time, wherein touch point coordinates of touch points are calculated by comparing the plurality of first signal values A_{1T}, A_{2T}, . . . , A_{iT} and comparing the plurality of second signal values B_{1T}, B_{1T}, . . . , B_{iT}.

14. The method of claim 13, wherein the touch point coordinates are calculated through making difference between each adjacent two of the plurality of first signal values, and making difference between each adjacent two of the plurality of second signal values.

15. The method of claim 14, wherein a first coordinate of a first touch point and a second coordinate of a second touch point are calculated through:
$${X}_{1} = \frac{{P}_{X}}{2} + \frac{( {A}_{jT} - {A}_{( j - 2 ) T} - ( {B}_{( i - k ) T} - {B}_{( i - k - 2 ) T} ) )}{( {A}_{jT} - {A}_{( j - 2 ) T} + ( {B}_{( i - k ) T} - {B}_{( i - k - 2 ) T} ) )} \times \frac{{P}_{X}}{2} ;$$
$${X}_{2} = \frac{{P}_{X}}{2} + \frac{( {A}_{kT} - {A}_{( k - 2 ) T} - ( {B}_{( i - j ) T} - {B}_{( i - j - 2 ) T} ) )}{( {A}_{kT} - {A}_{( k - 2 ) T} + ( {B}_{( i - j ) T} - {B}_{( i - j - 2 ) T} ) )} \times \frac{{P}_{X}}{2} ;$$
wherein P_{X} is a resolution of the X direction of the touch panel, A_{jT} is a first signal value sensed by the first electrode while the first electrode sensing the region Nⱼ at which the first touch point is located; A_{(j-2)T} is a signal value of regions from N₁ to Nⱼ₋₂ sensed by the first electrode during (j−2)T; A_{kT} is a second signal value sensed by the first electrode while the first electrode sensing the region Nₖ at which the second touch point is located; A_{(k-2)T} is a signal value of regions from N₁ to Nₖ₋₂ sensed by the first electrode during (k−2)T; B_{(i-k)T} is a third signal value sensed by the second electrode while the second electrode sensing the region M₍ᵢ₋ₖ₎ at which the second touch point is located; B_{(i-k-2)T} is a signal value of regions from M₁ to Mᵢ₋ₖ₋₂ sensed by the second electrode during (i−k−2)T; B_{(i-j)T} is a fourth signal value sensed by the second electrode while the second electrode sensing the region M₍ᵢ₋ⱼ₎ at which the first touch point is located; and B_{(i-j-2)T} is a signal value of regions from M₁ to Mᵢ₋ⱼ₋₂ sensed by the second electrode during (i−j−2)T.
